(19) United States
(12) Patent Application Publication
(10) Pub. No.: US 2010/0249257 A1
(43) Pub. Date: Sep. 30, 2010

(54) Crystalline polyolefin blend comprising polyhedral oligomeric silsesquioxane nanoparticles

(75) Inventors: Sadhan C. Jana, Fairlawn, OH (US); Byoung-Jo Lee, Cuyahoga Falls, OH (US)

Correspondence Address: HUDAK, SHUNK & FARINE, CO., L.P.A., 2020 FRONT STREET, SUITE 307, CUYAHOGA FALLS, OH, 44221, US

(73) Assignee: UNIVERSITY OF AKRON, Akron, OH (US)

(21) Appl. No.: 12/734,765

(22) PCT Filed: Nov. 21, 2008
(86) PCT No.: PCT/US08/12979

§ 371 Date: May 21, 2010

Related U.S. Application Data
(60) Provisional application No. 61/004,346, filed on Nov. 27, 2007.

(51) Int. Cl. C08J 9/00; C08L 23/00

(52) U.S. Cl. 521/134; 525/54.2

(57) ABSTRACT

A crystalline polyolefin blend comprising dispersed polyhedral oligomeric silsesquioxane (POSS) nanoparticles has improved packing of chains, high draw-down ratios, as well as improved tensile and yield strength. The blend is made by melt blending the polyolefin with the POSS in the presence of a sorbitol nucleating agent and cooling the mixture so that the nucleating agent serves as a template for the in-situ self assembly of dispersed POSS nanoparticles and the formation of very small crystalline polyolefin sites.

### FIELD OF THE INVENTION

The present invention relates to the formation of polyolefins having nano-size particles of polyhedral oligomeric silsesquioxane (POSS) therein. The nanoparticles are formed by melt blending POSS and the polyolefin in the presence of sorbitol nucleating agents that disperse the POSS so that it reinforces the polyolefin as well as forms very small crystalline polyolefin sites upon cooling of the melt blend. Such polyolefin blends show very high maximum drawn down ratios as well as improved properties such as tensile strength, yield strength, higher cold crystallization temperature, and better resiliency as compared to polyolefin blends having only either a sorbitol nucleating agent therein or only POSS therein.

### BACKGROUND OF THE INVENTION

Nucleating agents for polypropylene and other polyolefin matrix polymers generally have a saturation loading of less than 1 wt. %, which is desired for improved clarity. At such low loadings, the mechanical properties are not much affected by the network structures of the nucleating agent itself. On the other hand, improvements in mechanical properties with simultaneous improvement in clarity are desired in polyolefin products. This improvement can be achieved by reinforcing polyolefins with nanoparticulate fillers. This reinforcement can be achieved by “top-down” dispersion of nanoparticles, such as layered silicate clay, carbon nanotubes, fumed or precipitated silica, etc., or by “bottom-up” self-assembly approach, whereby dispersion of small molecules generate nanoparticles by flow-induced self-assembly process. The top-down approach however is fraught with poor dispersion and reportedly has been found to work only in a small number of cases. The bottom-up approach, on the other hand, has been used primarily by chemists, especially in generating colloidal particles. However, generating colloidal filler particles by in-situ chemical reactions has been found to be difficult.

U.S. Pat. No. 6,933,345 states that the nanoscopic dimensions of polyhedral oligomeric silsesquioxanes (POSS) and polyhedral oligomeric silicates (POS) materials range from 0.7 nm to 5.0 nm and enables the thermomechanical and physical properties of polymeric materials supposedly to be improved by providing nanoscopic reinforcement of polymer chains at a length scale that is not possible by physically smaller aromatic chemical systems or larger fillers and fibers. A method is set forth for incorporating POSS/POS nano-reinforcements onto polymers via the reactive grafting of suitably functionalized POSS/POS entities with polymeric systems.

U.S. Pat. No. 6,898,154 relates to a specific combination of two different polyolefin clarifying and nucleating agents, namely 3,4-dimethyldibenzylidene sorbitol and p-methyldibenzylidene sorbitol. Such a combination supposedly provides improved clarification and crystallization temperatures to polypropylene articles and formulations, better than bis-p-methyldibenzylidene sorbitol alone and equivalent or better than 3,4-dimethyldibenzylidene sorbitol.

U.S. Pat. No. 7,041,368 reportedly relates to permitting greater efficiency for high denier polypropylene fiber and yarn production. Generally, spinning speeds are limited for polypropylene fibers and yarns as such materials tend to break easily upon exposure to excessively high tensions associated with low- to medium-spinning speeds. As spinning is required to properly draw such high denier fibers sufficiently for fiber and yarn production, such limitations effectively prevent widespread utilization of such fibers and yarns in various end-use applications.

Heretofore, nucleating agents such as sorbitol derivatives have been known to improve the clarity and mechanical properties of isotactic polypropylene. However, the improvement in mechanical properties of polypropylene was small and even the utilization of large amounts of nucleating agents did not provide suitable improvements in mechanical properties.

The utilization of POSS in polyolefins is generally not suitable inasmuch as it does not function as a nucleating agent and hence has very little influence on the crystallization behavior. Moreover, the clarity of the polyolefins deteriorates at high loadings of POSS.

### SUMMARY OF THE INVENTION

It has been found that the utilization of one or more sorbitol nucleating agents in association with one or more polyhedral oligomeric silsesquioxanes unexpectedly and surprisingly yield improved results such as good clarity of the polyolefin, the formation of smaller crystalline polyolefin sites as well as synergistic improvements in properties such as draw-down ratios, higher denier fibers, tensile strength, and yield strength, higher cold crystallization temperature, and improved high temperature stability. As compared to the utilization of either the nucleating agent or the POSS alone, it has been surprisingly found that the sorbitol nucleating agents readily disperse the otherwise difficult to disperse POSS molecules. Further, the nucleating agents have been found to act as templates for self-assembly of POSS molecules and thus only small amounts of POSS molecules are required to obtain nanoparticles than otherwise normally utilized. These improvements are realized by utilizing commercial fiber spinning equipment and technology.

### BRIEF DESCRIPTION OF THE DRAWINGS

The present invention will be better understood by reference to the following drawings wherein all figures contain test values of a spun fiber containing 100 parts by weight of a polypropylene, 0.3 parts by weight of a dibenzylidene sorbitol (DBS) per 100 parts by weight of said polypropylene, and either 0, 5, 10, 15, 20, or 30 parts by weight of trisilanolphenyl (POSS) per 100 parts by weight of said polypropylene, wherein:

FIG. 1 relates to initial modulus;

FIG. 2 relates to tensile strength;

FIG. 3 relates to yield strength;

FIG. 4 relates to maximum draw down ratio; and

FIG. 5 relates to fiber diameter.

### DETAILED DESCRIPTION OF THE INVENTION

The polyolefins utilized in the present invention are copolymers or polymers desirably derived from olefin monomers containing from 2 to about 5 carbon atoms with 2 and 3 carbon atoms being preferred, that is ethylene and propylene. While any polymeric configuration can be utilized, with respect to polypropylene the isotactic configuration is preferred. A wide range of molecular weights can be utilized with one embodiment having a weight average molecular weight of from about 100,000 to about 800,000. The amount of the polyolefin is arbitrarily set at 100 parts by weight with the various one or more nucleating agents and the one or more POSS type compounds, as well as other compounds, being based thereupon.

The one or more nucleating agents of the present invention are generally substituted sorbitols or derivatives thereof with compounds containing hydroxyl groups being preferred. Examples of suitable sorbitol nucleating agents include, but are not limited to, dibenzylidene sorbitol (DBS), bis-p-methyldibenzylidene sorbitol (MDBS), bis-3,4-dimethyldibenzylidene sorbitol (3,4-DMDBS), bis(p-ethylbenzylidene) sorbitol (EDBS), 1,3;2,4-bis(5′,6′,7′,8′-tetrahydro-2-naphthylidene) sorbitol (TDBS), and the like. The DBS sorbitol nucleating agents and derivatives thereof are typically prepared by a condensation reaction of 2 moles of an aromatic alcohol with one mole of a polyhydric alcohol such as sorbitol. Specific sorbitol nucleating agents and the preparation thereof are as set forth in U.S. Pat. Nos. 3,721,682; 4,371,645; 4,429,140; 4,562,265; 4,902,807; 5,049,605; 5,731,474; 6,989,154; and 7,041,368, hereby fully incorporated by reference in their entirety. The one or more sorbitol nucleating agents and derivatives thereof of the present invention had been found to improve clarity of the various polyolefin polymers when utilized therein. Surprisingly, they have also been found to act as dispersing agents, especially with regard to the various one or more polyhedral oligomeric silsesquioxanes (POSS) of the present invention. Particularly suitable sorbitol nucleating agents are the various above noted sorbitol compounds that contain one or more hydroxyl groups therein that result in hydrogen bonding with the POSS compounds and thus act as a template for the in-situ self assembly of the POSS nanoparticles. The net result is an unexpected dispersion of the POSS compounds that reinforce the polyolefins as well as form very small crystalline polyolefin sites during melt blending thereof and primarily during subsequent cooling of polyolefins. The formations of such small crystalline polyolefin sites is thought to contribute to the unexpected and improved properties of the polyolefin such as maximum draw-down ratios, tensile strength, higher crystallization temperature of the polyolefin, better high temperature stability, as well as better resiliency.

The amount of the sorbitol nucleating agents is generally small such as from about 0.1 to about 2.0, desirably from about 0.1 to about 1.0, or from about 0.1 to about 0.75, and preferably from about 0.2 to about 0.5 or from about 0.2 to about 0.4, parts by weight for every 100 total parts by weight of the one or more polyolefin polymers. One or more different sorbitol nucleating agents can be utilized, with DBS, MDBS, and 3,4-DMDBS being preferred.

Numerous types of polyhedral oligomeric silsesquioxanes, i.e. POSS, compounds can be utilized in the present invention which result in a formation of small yet crystalline polyolefin sites. Examples of POSS compounds include those set forth in U.S. Patent Publication 2005/0239985, and U.S. Pat. Nos. 6,972,312; 6,933,345; 6,927,270; 6,911,518; 6,716,919; and 7,265,194, all hereby fully incorporated by reference in their entirety. Briefly, such POSS compounds can be defined as reactive or non-reactive POSS-polymer composites with fully or partially condensed cage structured POSS. These POSS molecules are characterized by the general formula (RSiO_{1.5})ₙ where R is an organic group which can be reactive or non-reactive and can contain a nitrile or a silonal group. Depending on the number n, POSS molecules are categorized as partial condensed structure (about 5 to less than 8), condensed cage structure (8 to 12), and random cage structure (higher than 12 to about 17). Specific examples of such different types of POSS compounds include trans-cyclohexanediolisobutyl POSS, 1,2-propanediolisobutyl POSS, aminopropylisobutyl POSS, aminopropylisooctyl POSS, aminoethylaminopropylisobutyl POSS, dodecaphenyl POSS, isooctyl POSS, phenylisobutyl POSS, phenylisooctyl POSS, isooctylphenyl POSS, isobutylphenyl POSS, octaisobutyl POSS, octamethyl POSS, octaphenyl POSS, cyanopropylisobutyl POSS, disinalolisobutyl POSS, trisilanolisobutyl POSS, trisilanolisooctyl POSS, trisilanolphenyl POSS (T-POSS), tetrasilanolphenyl POSS, and so on. Preferred POSS compounds include trans-cyclohexanediolisobutyl POSS, disinalolisobutyl POSS, trisilanolisobutyl POSS, trisilanolisooctyl POSS, trisilanolphenyl POSS (T-POSS), tetrasilanolphenyl POSS with nitriles and silanols as a R group.

The amount of the one or more POSS compounds utilized in the present invention is small and generally ranges from about 2 to about 18 or about 20 parts, desirably from about 3 to about 15 parts or from about 5 to about 14 parts, and preferably from about 7 to about 13 parts by weight per every 100 total parts by weight of the one or more polyolefins.

The one or more sorbitol nucleating agents and the one or more POSS compounds are physically blended and melt mixed with the one or more polyolefins in any manner and cooled to produce polyolefins having numerous small crystalline sites. The physical mixing can occur in any manner with desirably the sorbitol nucleating agents and the POSS compounds being first physically mixed together and then subsequently added to the polyolefin polymer that is generally in particle form and then melt mixed. The melt mixing naturally occurs above the melting point of the polyolefin and generally at a temperature of from about 170° C. to about 270° C., desirably from about 175° C. to about 225° C., and preferably from about 185° C. to about 210° C. with respect to isotactic polypropylene. Melting points of the various polyolefins will vary with regard to the type thereof, for example polyethylene or polybutylene, as well as the molecular weight thereof. Suitable melting point ranges can thus be readily determined and utilized so long as they are not at too a high temperature which tends to degrade the polyolefin.

A mixing procedure is desirably utilized that applies some shear to the POSS particles so that they are further broken down in size. Suitable shear mixers include Brabenders, various types of extruders, batch and continuous mixers, and the like. Since the POSS particles are somewhat soluble in the polyolefin, they are further broken up and dispersed. The mixing time will vary depending upon various factors such as the amount of polyolefin and the POSS particles, the sizes of the polyolefin and POSS particles, the amount of shear applied to the blend, and the like. Suitable mixing times generally are from about 0.5 to about 10 minutes. Upon the completion of melt mixing process, the blend of the one or more polyolefins, the one or more sorbitol nucleating agents, and the one or more POSS particles are cooled whereby the sorbitol nucleating agents act as a template for the in-situ self-assembly of POSS nanosized particles. Inasmuch as heretofore POSS compounds have been very difficult to disperse, it has been unexpectedly and surprisingly found that the utilization of sorbitol nucleating agents readily disperses and yields very fine size POSS particles in the blend generally with size after melt blending of from about 20 to about 900 and desirably from about 50 to about 500 nanometers in diameter. After cooling, the size of the polyolefin crystalline sites or domains containing POSS particles therein are very small such as from about 0.1 to about 500 microns and desirably from about 0.5 to about 100 microns in diameter. After sufficient cooling, the melt blended polyolefin is desirably formed into particles through any common and conventional method and apparatus such as by chopping, cutting, pelletizing, and the like. The size of the particles is generally not important and can vary greatly depending upon desirable end use.

The melt blended polyolefin polymers of the present invention containing very small crystalline sites can be subsequently shaped in many forms such as sheets, films, molded articles, pipes, fibers, and the like. A preferred end use is as a fiber. Fibers can be made utilizing standard and conventional melt spinning techniques wherein the polyolefin blended particles are melted at a temperature above the melting point of the polyolefin, for example from about 170° C. to about 220° C., etc. as set forth hereinabove with respect to isotactic polypropylene, and then subjected to a draw-down operation whereby thin fibers are formed. The thicknesses and denier of such fibers can vary depending upon the desired end use of the fabric made therefrom, with the fiber diameter often ranging from about 5 to about 200 microns, and desirably from about 10 to about 100 microns and the denier of a single fiber ranging from about 0.1 to about 5, and desirably from about 0.3 to about 2. The draw-down of the fibers aids in better packing of the molecules and also contributes to the improvement in the various properties noted herein. Spinning is the process of extruding polymer melts through a metal plate having a number of symmetrically arranged small holes, to form a corresponding number of continuous fluid strands. The fibers are mechanically very strong and highly anisotropic. Thus in the total process of fiber formation, not only shaping but also structuring takes place. All synthetic fibers are manufactured by spinning. In all spinning methods the liquid to be spun is pressurized in a container, and is forced out of the spinnerette. If a polymer melt is spun, the emerging extrudates are stretched and simultaneously cooled with a high velocity cross-current stream. Before the solid fibers are wound on the stretching spools, their cross-sectional area is reduced by a factor of 10-15. This may result in flow induced crystallization. The self-assembled POSS nanoparticles behave as a physical crosslinker that retards the local relaxation behavior of the surrounding chains and thus enhances the local molecular orientation. These stable oriented structures may be considered precursors for nucleation.

Due to the higher tensile strength, modulus, yield strength, etc., draw-down ratios can be achieved with various polyolefins which heretofore were generally unknown since the fiber would break at high draw-down ratios. Draw-down ratios of the present invention range from about 10:1 to about 1,000:1 or about 12,000:1 with ratios of greater than about 370:1, about 600:1, about 700:1, and even about 800:1 being readily achieved by the polyolefin blend of the present invention containing sorbitol nucleating agents and POSS compounds. As in the formation of the initial melt blending of the components of the present invention, some of the crystalline polyolefin sites are formed during melt blending or melt spinning of the fibers with the majority of the crystalline sites being formed upon cooling and solidification thereof.

Various optional additives can be utilized in the present invention such as plasticizers, antistatic agents, stabilizers, ultraviolet absorbers, antioxidants, perfumes, acid neutralizers, and the like. Such additives can be utilized in any amounts in order to provide the desired improvement, such as on the order from about 0.1 parts to about 10 parts by weight for every 100 parts by weight of the polyolefin.

### EXAMPLES

The invention will be better understood by reference to the following examples which serve to illustrate the invention, but not to limit the same.

In each of the four examples set forth in Table 1, the indicated amount of the various components were added to 100 parts by weight of pure polypropylene. An internal mixer, Brabender Plasticorder, type DR-2072, No. 0262/PE, manufactured by C. W. Brabender was used for mixing PP polymer with different types of POSS. The capacity of this mixer is 387 cm³ in one batch. The rotors, placed in the mixing bowl horizontally, turn in counter directions. A batch mixing time of 10 min and an angular speed of 70 rpm was used for preparation of the materials. The mixed materials were crushed into granules and melt-spun into fibers using a capillary rheometer (Instron) and a take-up device. The molten polymer was melt-spun as a monofilament through a capillary die (diameter: 1.6 mm, length-to-diameter ratio 19.3). The filaments were spun and cooled in ambient air at room temperature. The fiber diameter was varied by varying the plunger speed (0.1 in/min and 0.03 in/min) and take-up velocity (10 to 125 rpm) at constant melt temperature (190° C.). In this manner, the draw down ratio (DDR) ranged from 30 to 1200.

In each Example, 100 parts by weight of an isotactic polypropylene obtained from Equistar (PP31S07A) was utilized having a melt flow index of 0.7 grams per 10 minutes, a density of from 0.85 to 0.95 grams per cc (g/cc), and a melting point of about 168° C. The nucleating agent was DBS, that is 1,3:2,4-di(benzylidene) sorbitol obtained from Milliken Chemical having the tradename Millad 3905. The DBS had a density of 1.3 g/cc and a melting point of about 225° C. The POSS was an amphiphilic trisilanolphenyl-POSS (T-POSS) sold under the tradename S01458 from Hybrid Plastics and had a density of 1.1 g/cc and a melting point of about 400° C. or greater.

The tensile testing was conducted in accordance with ASTM D3822-01 wherein the gage length was 26 millimeters and the cross-head speed was 50 millimeters per minute (about 240% of gage length=62.4). The test results are set forth in Table 1.

TABLE 1

| | Conditions | Diameter | Tensile Modulus | Tensile Strength | Yield Strength | Elongation at Break |
|---|---|---|---|---|---|---|
| | (DDR) | (μm) | (GPa) | (MPa) | (MPa) | (%) |
| Example 1 | | | | | | |
| Pure polypropylene (PP) | 150 | 128 | 1.44 ± 0.1 | 129 ± 6 | 50 ± 2 | 998 ± 115 |
| 100 parts by wt. | 240 | 92 | 1.77 ± 0.3 | 138 ± 5 | 56 ± 2 | 1008 ± 114 |
| | 330 | Broken | | | | |
| Example 2 | | | | | | |
| 100 PPW-PP | 150 | 130 | 1.42 ± 0.2 | 131 ± 6 | 52 ± 1 | 964 ± 137 |
| 0.3 DBS PHPP | 240 | 104 | 1.82 ± 0.1 | 134 ± 10 | 54 ± 2 | 1010 ± 173 |
| | 330 | 77 | 2.35 ± 0.2 | 146 ± 10 | 64 ± 2 | 735 ± 123 |
| | | | (133%) | | | |
| | 370 | 80 | 2.23 ± 0.1 | 144 ± 10 | 65 ± 2 | 724 ± 115 |
| | 600 | 64 (70%) | 2.23 ± 0.1 | 165 ± 4 | 65 ± 6 | 806 ± 56 |
| | | | | (120%) | (116%) | |
| | 700 | Broken | | | | |
| Example 3 | | | | | | |
| 100 PPW PP | 150 | 116 | 1.36 ± 0.7 | 99 ± 26 | 44 ± 11 | 652 ± 195 |
| T-POSS (p) 10 PHPP | 240 | Broken | | | | |
| Example 4 | | Actual | Actual | Actual | Actual | Actual |
| 100 PPW PP | 150 | 114 | 1.58 ± 0.1 | 145 ± 12 | 48 ± 4 | 767 ± 143 |
| DBS/T-POSS (p) | 240 | 97 | 1.85 ± 0.2 | 141 ± 12 | 54 ± 4 | 898 ± 139 |
| 0.3/10 PHPP | 330 | 83 | 2.03 ± 0.2 | 125 ± 12 | 56 ± 4 | 670 ± 73 |
| | 370 | 75 | 2.26 ± 0.1 | 134 ± 7 | 63 ± 3 | 726 ± 51 |
| | 600 | 60 | 2.54 ± 0.1 | 160 ± 5 | 67 ± 1 | 709 ± 52 |
| | 700 | 57 | 2.45 ± 0.2 | 170 ± 6 | 71 ± 2 | 744 ± 58 |
| | 800 | 47 (51%) | 2.86 ± 0.6 | 174 ± 5 | 80 ± 3 | 643 ± 44 |
| | | | (162%) | (126%) | (143%) | |

| | |
|---|---|
| 900 | Broken |

An analysis of Table 1 reveals that unexpected and synergistic results were obtained when a POSS compound was utilized in association with a sorbitol nucleating agent with respect to an increase in modulus and tensile strength at a draw-down ratio of 150. Examples 3 (Control) and 4 (Invention) of Table 1 each contains 10 parts by weight of T-POSS per 100 parts by weight of polypropylene. Since a blend of polypropylene containing 10 parts by weight of T-POSS could not be made in draw-down ratios generally above 150, comparisons at higher draw-down ratios cannot be made. However, comparing Example 2 wherein a DBS nucleating agent was utilized with Example 4, the present invention, wherein the same amount of the DBS nucleating agent was utilized along with 10 parts by weight of T-POSS, the present invention achieved higher draw-down ratios and at the same draw-down ratio generally had thinner fibers. Comparing the properties of Example 2 with Example 4 at the maximum draw-down ratios of each, it is readily apparent that even though the present invention yielded a thinner diameter fiber, i.e. 47 microns versus 64 microns, significantly better modulus values, i.e. 2.86 versus 2.23 GPa, tensile strength, i.e. 174 versus 165 MPa, and better yield strength, i.e. 80 versus 65 MPa. Since the area of the fiber of the present invention, that is Example 4, was only 54% of that of the fiber area of the fiber of Example 2, the improved results would be much greater when based upon the same fibers having the same area.

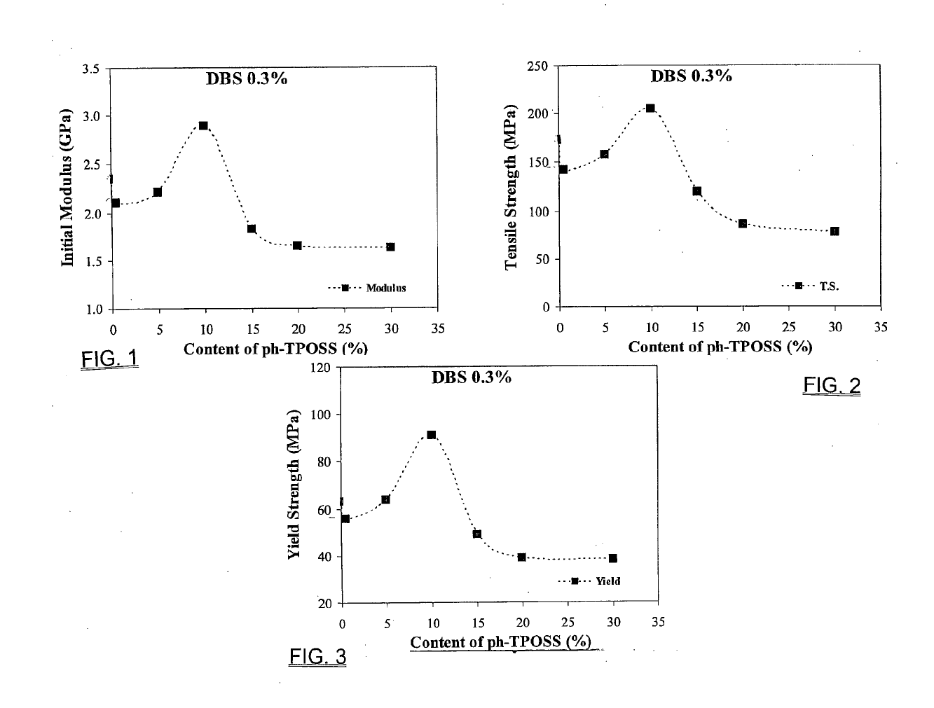

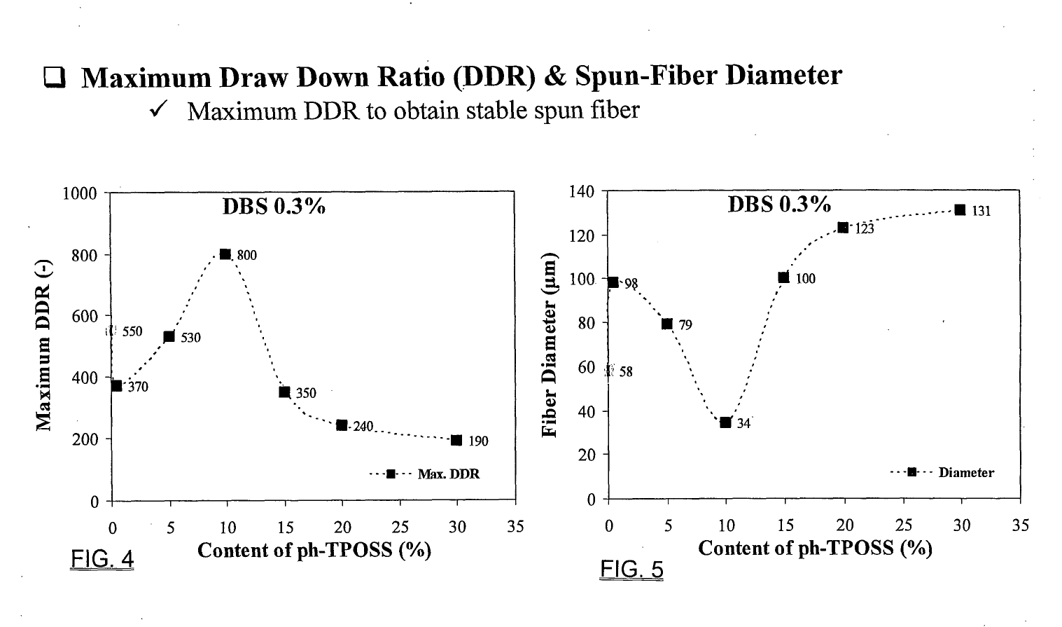

In a manner as set forth above, tests were carried out on fibers wherein the amount of T-POSS was 5, 10, 15, 20, and 30 parts by weight per 100 parts by weight of polypropylene. The results are set forth in FIGS. 1 through 5, respectively, with regard to initial modulus (FIG. 1), tensile strength (FIG. 2), yield strength (FIG. 3), draw down ratios (FIG. 4), and fiber diameter (FIG. 5). In all figures, improved properties were obtained wherein the amount of POSS was from about 3 to about 15 parts by weight, desirably from about 5 to about 14 parts by weight, and preferably from about 7 to about 13 parts by weight of POSS per 100 parts by weight of polypropylene as compared to when POSS (i.e. zero parts by weight) as utilized in all five figures, the amount of the Sorbitol nucleating agent was 0.3 parts by weight per 100 parts by weight of the polypropylene.

The various polyolefins of the present invention in having improved mechanical properties including a high draw-down ratio can be used in a variety of articles, including, but not limited to, armor applications such as antiballistic cloth, helmets, vests, vehicle armor panels, and the like, for industrial applications including ropes, nets, and for medical uses such as fibers, cloth, gloves, and the like.

In accordance with the patent statutes, the best mode and preferred embodiment have been set forth, the scope of the invention is not limited thereto, but rather by the scope of the attached claims.

What is claimed is:

1. A melt-blended polymer, comprising:
100 parts by weight of a polyolefin derived from one or more olefin monomers having from 2 to about 5 carbon atoms;
from about 0.1 to 2 parts by weight of one or more sorbitol nucleating agents; and
from about 2 to about 20 parts by weight of one or more polyhedral oligomeric silsesquioxane (POSS) compounds.

2. The melt-blended polymer according to claim 1, wherein said sorbitol nucleating agent, includes a substituted sorbitol, or a derivative of a sorbitol, wherein the amount of said nucleating agent is from about 0.1 to about 1.0 part by weight per 100 parts by weight of said one or more olefins; wherein said one or more POSS compounds have the formula (RSiO_{1.5})ₙ wherein R is an organic group that can be reactive or non-reactive and optionally can contain a nitrile group or a silanol group, wherein n is from about 5 to about 17, and wherein the amount of said POSS compound is from about 3 to about 15 parts by weight per 100 parts by weight of said one or more polyolefins.

3. The melt-blended polymer according to claim 1, wherein said polyolefin is polyethylene, polypropylene, or a combination thereof, wherein said sorbitol comprises dibenzylidene sorbitol (DBS), bis-p-methyldibenzylidene sorbitol (MDBS), bis-3,4-dimethyldibenzylidene sorbitol (3,4-DMDBS), bis(p-ethylbenzylidene) sorbitol (EDBS), or 1,3;2,4-bis(5′,6′,7′,8′-tetrahydro-2-naphthylidene) sorbitol (TDBS), or any combination thereof; where said POSS compound comprises trans-cyclohexanediolisobutyl POSS, 1,2-propanediolisobutyl POSS, aminopropylisobutyl POSS, aminopropylisooctyl POSS, aminoethylaminopropylisobutyl POSS, dodecaphenyl POSS, isooctyl POSS, phenylisobutyl POSS, phenylisooctyl POSS, isooctylphenyl POSS, isobutylphenyl POSS, octaisobutyl POSS, octamethyl POSS, octaphenyl POSS, disinalolisobutyl POSS, cyanopropylisobutyl POSS, trisilanolisobutyl POSS, trisilanolisooctyl POSS, trisilanolphenyl POSS (T-POSS), or tetrasilanolphenyl POSS, or any combination thereof, and wherein the amount of said one or more POSS compounds is from about 5 to about 14 parts by weight per 100 parts by weight of said polyethylene, or said polypropylene, or said combination thereof.

4. The melt-blended polymer according to claim 3, wherein said sorbitol nucleating agent is dibenzylidene sorbitol (DBS), bis-p-methyldibenzylidene sorbitol (MDBS), or bis-3,4-dimethyldibenzylidene sorbitol (3,4-DMDBS), or any combination thereof; wherein the amount of said sorbitol nucleating agent is from about 0.2 to about 0.5 parts by weight per 100 parts by weight of said polyethylene, said polypropylene, or said combination thereof; wherein said POSS compound is trans-cyclohexanediolisobutyl POSS, disinalolisobutyl POSS, trisilanolisobutyl POSS, trisilanolisooctyl POSS, trisilanolphenyl POSS, or tetrasilanolphenyl POSS, or any combination thereof, and wherein the amount of said POSS compound is from about 7 to about 13 parts by weight per 100 parts by weight of said polyethylene, or said polypropylene, or said combination thereof.

5. The melt-blended polymer according to claim 4, wherein said polyethylene, or said polypropylene, or said combination thereof is isotactic; wherein the amount of said sorbitol nucleating agent is from about 0.2 to about 0.4 parts by weight per 100 parts by weight of said polyethylene, or said polypropylene, or said combination thereof; and wherein said melting point of said polyethylene, or said polypropylene, or said combination thereof is from about 70° C. to about 270° C.

6. A spun fiber comprising the melt-blended polymer of claim 1.

7. A spun fiber comprising the melt-blended polymer of claim 4.

8. A blown film comprising the melt-blended polymer of claim 1.

9. A blown film comprising the melt-blended polymer of claim 4.

10. A cast film comprising the melt-blended polymer of claim 1.

11. A cast film comprising the melt-blended polymer of claim 4.

12. A process for forming a polyolefin blend comprising the steps of:
melt-mixing from about 0.1 to about 2.0 parts by weight of one or more sorbitol nucleating agents and from about 2 to about 20 parts by weight of one or more polyhedral oligomeric silsesquioxane (POSS) compounds per 100 parts by weight of a polyolefin, said polyolefin being derived from one or more monomers having from 2 to about 5 carbon atoms;
conducting said melt-mixing at a temperature above the melting point of said polyolefin; and
subsequently cooling said melted polyolefin-nucleating agent-POSS blend to solidify said blend and forming small crystalline polyolefin sites therein.

13. The process of claim 12, wherein said sorbitol nucleating agent, includes a substituted sorbitol, or a derivative of a sorbitol, wherein the amount of said nucleating is from about 0.1 to about 1.0 by weight per 100 parts by weight of said one or more olefins; wherein said one or more POSS compounds have the formula (RSiO_{1.5})ₙ wherein R is an organic group that can be reactive or non-reactive and optionally can contain a nitrile group or a silane group, wherein n is from about 5 to about 17, and wherein the amount of said POSS compound is from about 3 to about 15 parts by weight per 100 parts by weight of said one or more polyolefins.

14. The process of claim 12, wherein said polyolefin is polyethylene, polypropylene, or a combination thereof, wherein said sorbitol comprises dibenzylidene sorbitol (DBS), bis-p-methyldibenzylidene sorbitol (MDBS), bis-3,4-dimethyldibenzylidene sorbitol (3,4-DMDBS), bis(p-ethylbenzylidene) sorbitol (EDBS), or 1,3;2,4-bis(5′,6′,7′,8′-tetrahydro-2-naphthylidene) sorbitol (TDBS), or any combination thereof; where said POSS compound comprises trans-cyclohexanediolisobutyl POSS, 1,2-propanediolisobutyl POSS, aminopropylisobutyl POSS, aminopropylisooctyl POSS, aminoethylaminopropylisobutyl POSS, dodecaphenyl POSS, isooctyl POSS, phenylisobutyl POSS, phenylisooctyl POSS, isooctylphenyl POSS, isobutylphenyl POSS, octaisobutyl POSS, octamethyl POSS, octaphenyl POSS, disinalolisobutyl POSS, cyanopropylisobutyl POSS, trisilanolisobutyl POSS, trisilanolisooctyl POSS, trisilanolphenyl POSS (T-POSS), or tetrasilanolphenyl POSS, or any combination thereof, and wherein the amount of said one or more POSS compounds is from about 5 to about 14 parts by weight per 100 parts by weight of said polyethylene, or said polypropylene, or said combination thereof.

15. The process of claim 14, wherein said melt-mixing is at a temperature of from about 170° C. to about 270° C., and wherein said crystalline polyolefin sites are from about 0.1 to about 500 microns in diameter.

16. The process of claim 15, wherein said sorbitol nucleating agent is dibenzylidene sorbitol (DBS), bis-p-methyldibenzylidene sorbitol (MDBS), or bis-3,4-dimethyldibenzylidene sorbitol (3,4-DMDBS), or any combination thereof; wherein the amount of said sorbitol nucleating agent is from about 0.2 to about 0.5 parts by weight per 100 parts by weight of said polyethylene, said polypropylene, or said combination thereof; wherein said POSS compound is trans-cyclohexanediolisobutyl POSS, disinalolisobutyl POSS, trisilanolisobutyl POSS, trisilanolisooctyl POSS, trisilanolphenyl POSS, or tetrasilanolphenyl POSS, or any combination thereof, and wherein the amount of said POSS compound is from about 7 to about 13 parts by weight per 100 parts by weight of said polyethylene, or said polypropylene, or said combination thereof.

17. The process of claim 16, wherein said polyethylene, or said polypropylene, or said combination thereof is isotactic; wherein the amount of said sorbitol nucleating agent is from about 0.2 to about 0.4 parts by weight per 100 parts by weight of said polyethylene, or said polypropylene, or said combination thereof; wherein said melt-mixing is at a temperature of from about 175° C. to about 225° C. and wherein said crystalline polyolefin sites are from about 0.5 to about 100 microns in diameter.

18. The process of claim 12, including melt-spinning said polyolefin-nucleating agent-POSS solid blend into a fiber.

19. The process of claim 15, including melt-spinning said polyolefin-nucleating agent-POSS solid blend into a fiber.

20. The process of claim 12, including forming said polyolefin-nucleating agent-POSS solid blend into a blown film.

21. The process of claim 15, including forming said polyolefin-nucleating agent-POSS solid blend into a blown film.

22. The process of claim 12, including forming said polyolefin-nucleating agent-POSS solid blend into a cast film.

23. The process of claim 15, including forming said polyolefin-nucleating agent-POSS solid blend into a cast film.
